(19) United States
(12) Patent Application Publication
(10) Pub. No.: US 2023/0213676 A1
(43) Pub. Date: Jul. 6, 2023

(54) UNSUPERVISED MACHINE-LEARNING MODEL FOR DETERMINING CHANNELS IN A WELLBORE

(71) Applicant: Halliburton Energy Services, Inc., Houston, TX (US)

(72) Inventors: Amit Padhi, Cypress, TX (US); Ho Yin Ma, Singapore (SG); Qingtao Sun, Spring, TX (US); Jing Jin, Singapore (SG)

(21) Appl. No.: 17/568,688

(22) Filed: Jan. 4, 2022

(51) Int. Cl. G01V 1/50; G06N 20/00

(52) U.S. Cl. CPC G01V 1/50; G06N 20/00

(57) ABSTRACT

A system can apply an unsupervised machine-learning model to ultrasonic waveform data received about a wellbore for identifying channels in the wellbore. A system can receive ultrasonic waveform data about a wellbore using an arrangement of transducers positionable in the wellbore. The ultrasonic waveform data can include a set of ultrasonic waveforms. The system can generate a set of attributes for each ultrasonic waveform of the set of ultrasonic waveforms. The system can apply an unsupervised machine-learning model to the set of ultrasonic waveforms for clustering the set of attributes of ultrasonic waveform into a set of clusters. The system can output the set of clusters for categorizing the ultrasonic waveform data.

### TECHNICAL FIELD

The present disclosure relates generally to wellbore operations, and more particularly (although not necessarily exclusively), to identifying annular channels in a wellbore using an unsupervised machine-learning model.

### BACKGROUND

A wellbore can be formed in a subterranean formation and can be used to extract produced hydrocarbon material. One or more wellbore operations can be performed with respect to the wellbore. For example, the wellbore operations can include a drilling operation, a stimulation operation, a production operation, other suitable wellbore operations, or any combination thereof. The wellbore operations may involve installing a casing in the wellbore, setting cement in the wellbore, and the like. In some examples, gaps may be formed between the casing and the cement in the wellbore, or in other suitable locations. Some gaps may affect the wellbore operations. For example, some gaps may cause failures or other undesirable effects with respect to the wellbore operations, but other gaps may not cause any undesirable effects. Measuring or otherwise identifying the gaps that may cause failures may be difficult since the gaps can be positioned between the casing and the cement. Other techniques or models may not be able to measure or identify the gaps between the casing and the cement that may cause failures or other suitable or related gaps in the wellbore.

### BRIEF DESCRIPTION OF THE DRAWINGS

FIG. 1 is a schematic of a well system that includes a pitch-catch arrangement of transducers for receiving ultrasonic waveform data relating to a wellbore according to one example of the present disclosure.

FIG. 2 is a block diagram of a computing system that can apply an unsupervised machine-learning model for identifying channels in a wellbore according to one example of the present disclosure.

FIG. 3 is a flow chart of a process to apply an unsupervised machine-learning method for identifying channels in a wellbore according to one example of the present disclosure.

FIG. 4 is an example of synthetic waveforms representing various annular conditions of a wellbore according to one example of the present disclosure.

FIG. 5 is an example of clusters output from an unsupervised machine-learning model and associated with ultrasonic waveform data about a wellbore according to one example of the present disclosure.

### DETAILED DESCRIPTION

Certain aspects and examples of the present disclosure relate to applying an unsupervised machine-learning method to ultrasonic waveform data received about a wellbore for identifying channels in the wellbore. The ultrasonic waveform data can include a set of ultrasonic data, including ultrasonic waveforms that can be collected from the wellbore. The ultrasonic waveform data can be gathered using various techniques, such as a pitch-catch technique performed using transducers in a pitch-catch arrangement. An unsupervised machine-learning model can include the application of artificial intelligence (AI) or other suitable machine-learning techniques for finding patterns in datasets, such as the ultrasonic waveform data, without labels or classifications. For example, the unsupervised machine-learning model may find or otherwise identify patterns within the ultrasonic waveform data. The unsupervised machine-learning model can be used for determining channels in the wellbore. For example, the unsupervised machine-learning model can cluster the ultrasonic waveform data for determining categories of annular conditions outside of a casing of the wellbore. The categories can include channels, microannuli, and other suitable categories with respect to the wellbore.

In some examples, an unsupervised machine-learning technique can be leveraged to detect annular channels with higher confidence compared to other techniques that use lamb modes based on acoustic properties maps. The annular channels can be identified despite the existence of microannuli, which can include small-diameter (e.g., less than 100 microns or 0.004 inches) holes or channels behind the casing or between the casing and cement in the wellbore. In some examples, the ultrasonic waveform data can include information extending to the cement-formation interface that can be collected using tilted transducers for generating flexural waves in the casing and for leaking energy into the annulus. The flexural waves can be used with respect to one or more wellbore operations, for post-processing operations, and for other suitable operations with respect to the wellbore.

In some examples, ultrasonic waveform data can be collected via a pitch-catch arrangement of transducers (e.g., sources and receivers). The source can be tilted at one or more angles to generate a flexural casing mode. The ultrasonic waveforms from various azimuths can be processed to generate multiple signal attributes for each ultrasonic waveform. Based on the signal attributes, an unsupervised machine-learning model or algorithm can be used to find corresponding clusters to club each ultrasonic waveform into an appropriate cluster related to one or more annular conditions. In some examples, by checking ultrasonic waveforms in each cluster and recognizing similar annular conditions within the same cluster, azimuths that may include a high probability of having radially thick channel behind the casing can be separated from azimuths that may include radially thin channels or microannuli behind the casing. In some examples, pulse-echo acoustic measurements can be used in addition to the ultrasonic waveform data collected via the pitch-catch arrangement for clustering operations.

Separating microannuli from annular channels using pulse-echo measurements based acoustic impedance maps can be difficult. A pitch-catch arrangement of transducers to induce and collect flexural wave data can provide additional information. The additional information can be utilized either alone or in combination with acoustic impedance estimates to make the distinction between microannuli and annular channels due to differing physics or physical properties associated with flexural wave generation and pulse-echo-based wave-mode generation. An unsupervised machine learning approach can provide a technique or method to utilize information included in the data to separate the different annular conditions (e.g., channels, micorannuli, etc.) behind the casing.

In some examples, a clustering algorithm can be applied using unsupervised machine learning techniques that may not label data for training and subsequent predictions. The unsupervised machine-learning techniques can find or otherwise identify naturally occurring patterns in data sets without further feeding with training data. In some examples, the unsupervised machine-learning can distinguish or help distinguish the significant channels from microannuli without human or other devices labeling annular conditions for each ultrasonic waveform in advance. Using the unsupervised machine-learning model can reduce time and resource costs associated with identifying the channels and microannuli in the wellbore.

In some examples, the ultrasonic waveform data can be categorized by extracting attributes out of each ultrasonic waveform of the ultrasonic waveform data. In order to leverage a clustering algorithm, for example, K-means clustering, attributes can be calculated for each ultrasonic waveform. The clustering algorithm may include other suitable alternatives to K-means clustering including, for example, mean-shift clustering, agglomerative hierarchical clustering, fuzzy clustering, etc. In some examples, extracting attributes from each ultrasonic waveform trace, which can be a time series, can involve selecting a time window of interest. The time window of interest can begin at an arrival time of a primary flexural wave, obtained from ray tracing, and can end at around 0.1 milliseconds (or other suitable amount of time) after that. Once selected, the time window of interest can be divided into multiple segments and the absolute values of the amplitudes to each segment can be added. Accordingly, the attributes can define (or otherwise represent suitable information about) each waveform. Other suitable attributes (e.g., attributes determined using other suitable techniques) can be used or determined.

In some examples, based on the attributes, the clustering algorithm can cluster the waveforms into multiple clusters. An amount of the categories can be selected in advance, or otherwise predetermine, by using an optimization method such as the Elbow Method. The Elbow Method can test the clustering algorithm based on the reduction of sum of squared errors versus the number of clusters or categories to provide the optimal amount of categories. Other suitable optimization methods or techniques can be used for determining an optimal amount of clusters or categories such as, for example, silhouette analysis, and the Davies-Bouldin index.

In some examples, in response to the clustering operation, the clusters can be labeled either manually or in determination with some automatic numerical criteria. Labeling can refer to the process of assigning a name to a category. For example, a category can be labeled as cement behind casing, free pipe in the air, dry microannulus with partial touching, and free pipe in the water, or other suitable labels. The waveforms corresponding to channels behind casing can be clustered separately from those corresponding to microannuli behind casing, which may correspond more closely to fully bonded case waveforms.

The above illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

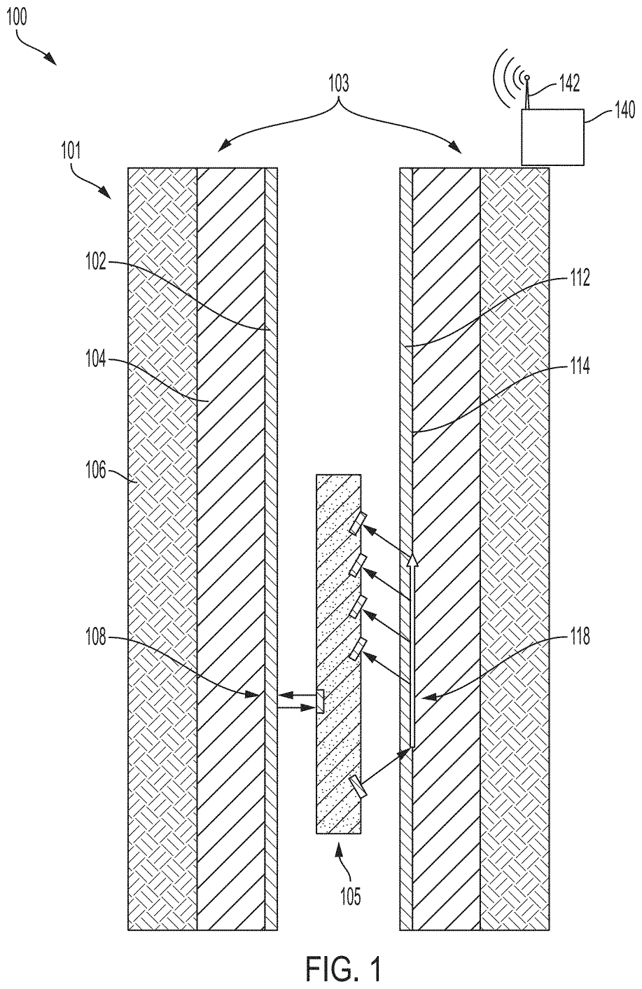

FIG. 1 is a schematic of a well system 100 that includes a pitch-catch arrangement of transducers for receiving ultrasonic waveform data relating to a wellbore according to one example of the present disclosure. The well system 100 can include a wellbore 101 extending through various earth strata. The wellbore 101 can extend through a subterranean formation 106 that can include an annulus 104, and the subterranean formation 106 can additionally include hydrocarbon material such as oil, gas, coal, or other suitable material. In some examples, a casing 102 can extend from a well surface 103 into the subterranean formation 106. The casing 102 can provide a conduit through which formation fluids (or other suitable fluids), such as production fluids produced from the subterranean formation 106, can travel to the well surface 103. Additionally, a first interface 112, which contacts mud (which can be positioned in the casing 102 or otherwise suitably in the wellbore 101) and the casing 102 can allow the pitch-catch arrangement of transducers 118 to be positioned in the wellbore 101 for transmitting and receiving ultrasonic waveform data. A second interface 114, which can contact the casing 102 and the annulus 104, can be coupled to walls of the wellbore 101 via cement or other suitable coupling material. For example, a cement sheath in the annulus 104 can be positioned or formed between the casing 102 and the walls of the wellbore 101 for coupling the casing 102 to the wellbore 101. The casing 102 can be coupled to the wellbore 101 using other suitable techniques.

In some examples, the well system 100 can include at least one well tool 105 that can include, can be included in, or can otherwise be associated with the pitch-catch arrangement of transducers 118. In other examples, the well system 100 can include at least one well tool 105 that can include, can be included in, or can otherwise be associated with the pulse-echo arrangement of transducers 108. An arrangement of pitch-catch and pulse-echo transducers can be used in collecting flexural wave data. Transducers for pitch-catch acquisition can be tilted at, for example, 35 degrees with respect to a longitudinal axis of the tool. Other suitable angles can be used for the tilt of the transducers.

A computing device 140 can be positioned at the surface 103 of the well system 100. In some examples, the computing device 140 can be positioned downhole in the wellbore 101, remote from the well system 100, or in other suitable locations with respect to the well system 100. The computing device 140 can be communicatively coupled to the pitch-catch arrangement of transducers 118, the well tool 105, or other suitable components of the well system 100, via one or more wired connections or wireless connections. For example, as illustrated in FIG. 1, the computing device 140 can include an antenna 142 that can allow the computing device 140 to receive and to send communications relating to the well system 100. The computing device 140 can receive the downhole acquisition data and other suitable data from the pitch-catch arrangement of transducers 118, or other suitable components of the well system 100. The computing device 140 can use the received acquisition data to generate or otherwise determine ultrasonic waveform data associated with the wellbore 101. In some examples, the computing device 140 can output the ultrasonic waveform data for use in one or more wellbore operations or other suitable operations with respect to the well system 100.

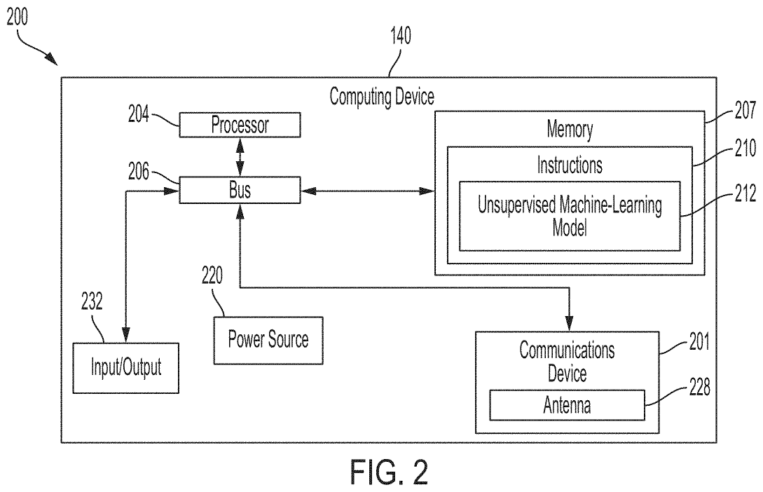

FIG. 2 is a block diagram of a computing system 200 that can apply an unsupervised machine-learning model for identifying channels in a wellbore according to one example of the present disclosure. The components shown in FIG. 2, such as the processor 204, memory 207, power source 220, communications device 201, and the like may be integrated into a single structure such as within a single housing of a computing device 140. Alternatively, the components shown in FIG. 2 can be distributed from one another and in electrical communication with each other.

The computing system 200 may include the computing device 140. The computing device 140 can include a processor 204, a memory 207, and a bus 206. The processor 204 can execute one or more operations for applying an unsupervised machine-learning model for identifying channels and microannuli with respect to the wellbore 101. The processor 204 can execute instructions stored in the memory 207 to perform the operations. The processor 204 can include one processing device or multiple processing devices or cores. Non-limiting examples of the processor 204 include a Field-Programmable Gate Array (“FPGA”), an application-specific integrated circuit (“ASIC”), a microprocessor, etc.

The processor 204 can be communicatively coupled to the memory 207 via the bus 206. The non-volatile memory 207 may include any type of memory device that retains stored information when powered off. Non-limiting examples of the memory 207 may include EEPROM, flash memory, or any other type of non-volatile memory. In some examples, at least part of the memory 207 can include a medium from which the processor 204 can read instructions. A computer-readable medium can include electronic, optical, magnetic, or other storage devices capable of providing the processor 204 with computer-readable instructions or other program code. Non-limiting examples of a computer-readable medium include (but are not limited to) magnetic disk(s), memory chip(s), ROM, RAM, an ASIC, a configured processor, optical storage, or any other medium from which a computer processor can read instructions. The instructions can include processor-specific instructions generated by a compiler or an interpreter from code written in any suitable computer-programming language, including, for example, C, C++, C #, etc.

In some examples, the memory 207 can include computer program instructions 210 for determining channels in the wellbore 101. For example, the computer program instructions 210 can include an unsupervised machine-learning model 212 that can be executed by the processor 204 for causing the processor 204 to perform various operations. For example, the unsupervised machine-learning model 212 can receive and pre-process downhole acquisition data related to the wellbore 101. The unsupervised machine-learning model 212 can additionally cluster the ultrasonic waveform data and determine, using the pre-processed downhole acquisition data, a set of attributes that may represent each ultrasonic waveform. The unsupervised machine-learning model 212 can cluster the ultrasonic waveform data, using the set of attributes, into a set of clusters. The set of clusters may represent one or more types of annular conditions. The set of clusters can be output for subsequent use (e.g., for determining the annular channels, etc.).

The computing device 140 can include a power source 220. The power source 220 can be in electrical communication with the computing device 140 and the communications device 201. In some examples, the power source 220 can include a battery or an electrical cable (e.g., a wireline). The power source 220 can include an AC signal generator. The computing device 140 can operate the power source 220 to apply a transmission signal to the antenna 228 to generate electromagnetic waves that convey data relating to the wellbore 101, the unsupervised machine-learning model 212, etc., to other systems. For example, the computing device 140 can cause the power source 220 to apply a voltage with a frequency within a specific frequency range to the antenna 228. This can cause the antenna 228 to generate a wireless transmission. In other examples, the computing device 140, rather than the power source 220, can apply the transmission signal to the antenna 228 for generating the wireless transmission.

In some examples, a subset of the communications device 201 can be implemented in software. For example, the communications device 201 can include additional instructions stored in memory 207 for controlling functions of the communication device 201. The communications device 201 can receive signals from remote devices and transmit data to remote devices. For example, the communications device 201 can transmit wireless communications that are modulated by data via the antenna 228. In some examples, the communications device 201 can receive signals (e.g. associated with data to be transmitted) from the processor 204 and amplify, filter, modulate, frequency shift, or otherwise manipulate the signals. In some examples, the communications device 201 can transmit the manipulated signals to the antenna 228. The antenna 228 can receive the manipulated signals and responsively generate wireless communications that carry the data.

The computing device 140 can additionally include an input/output interface 232. The input/output interface 232 can include or otherwise connect to a keyboard, pointing device, display, and other computer input/output devices. An operator may provide input using the input/output interface 232. Data, such as downhole acquisition data, ultrasonic waveform data, etc., relating to the wellbore 101 can be displayed to an operator or other suitable individual via a display that is connected to or that may be part of the input/output interface 232. The displayed values can be displayed to the operator, or to a supervisor, of one or more wellbore operations associated with the wellbore 101.

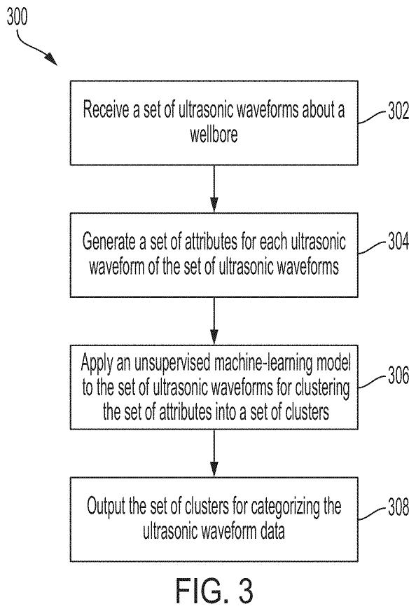

FIG. 3 is a flow chart of a process 300 to apply an unsupervised machine-learning model 212 for identifying channels in a wellbore 101 according to one example of the present disclosure. At block 302, the computing device 140 receives ultrasonic waveform data from an arrangement of transducers positioned in the wellbore 101. The ultrasonic waveform data can include a set of ultrasonic waveforms. The arrangement of transducers can include one or more pitch-catch arrangements of sources and receivers. The pitch-catch arrangement of transducers can be used for transmitting or receiving acquisition data by ultrasound devices and the like.

The ultrasonic waveform data can be collected using a pitch-catch arrangement of transducers with a tilted (e.g. tilted at 35 degrees or other suitable angles) source to induce flexural waves in the casing 102. The flexural waves can leak energy into the annulus 104. Accordingly, reflections can be received at the pitch-catch arrangement of transducers. To process the acquisition data into ultrasonic waveform data by the computing devices 140, the received ultrasonic data can be segmented into various ultrasonic waveforms. Since each trace in the acquisition data may include different arrival times within a certain time window, flexural wave data can be generated due to different arrival times and can be transformed into ultrasonic waveforms for respective time windows by the computing device 140

At block 304, the computing device 140 processes each ultrasonic waveform from the ultrasonic waveform data to obtain a set of attributes for each ultrasonic waveform. Each set of attributes can include features that can characterize a corresponding ultrasonic waveform. In some examples, the set of attributes can be generated by the azimuthal technique and can be processed by the computing device 140 into ultrasonic waveforms. In some examples, the set of attributes can be determined based on signals or ultrasonic waveforms from more than one receiver in the pitch-catch arrangement. The set of attributes can be determined using any other suitable techniques.

At block 306, the computing device 140 applies an unsupervised machine-learning model 212 to the set of ultrasonic waveforms for clustering each set of attributes of the ultrasonic waveform into a set of clusters. The computing device 140 can apply a clustering algorithm (e.g., K-means clustering or the like) via the unsupervised machine-learning model 212 for categorizing the ultrasonic waveforms generated from extended azimuths. In some examples, the computing device 140 can determine a number of clusters before clustering each ultrasonic waveform by using an optimization technique (e.g., the Elbow Method). The number of clusters can be used for determining how many types of annular conditions behind the casing 102 can be suitably clustered. In some examples, the computing device 140 can select at least some attributes of each ultrasonic waveform to cluster into the set of clusters via a clustering algorithm. In some examples, the computing device 140 can cluster the attributes from each ultrasonic waveform, and a subset of the attributes can be selected for further use in the clustering process for reducing computing complexity or computing time. Accordingly, in some examples, the computing device 140 may use a subset of the attributes for clustering ultrasonic waveforms. In some examples, the computing device 140 can cluster ultrasonic waveforms by using other suitable clustering algorithms such as mean-shift clustering, agglomerative hierarchical clustering, and fuzzy clustering depending on the type of attributes and other suitable factors.

At block 308, the computing device 140 outputs the set of clusters from categorizing the ultrasonic waveform data of the wellbore 101. In some examples, the computing device 140 can output the set of clusters for display (e.g., via the input/output interface 232). The set of clusters can be represented as an azimuthal scan diagram that illustrates each ultrasonic waveform with associated labeling relating to cluster assigned by the unsupervised machine-learning model 212. In some examples, the set of clusters can be represented as a two-dimension plot or diagram that illustrates each ultrasonic waveform with associated label (e.g., a circle with associated labeling) assigned by the unsupervised machine-learning model 212. In some examples, the set of clusters output by the computing device 140 can be used as labeled data to train a second machine-learning model (e.g., a supervised machine-learning model) for determining the annular conditions of the wellbore 101 or for other suitable purposes.

The output from the computing device 140 can be used to control one or more wellbore operations. For example, the set of clusters, the associated annular conditions, or a combination thereof can be used to control a remediation operation with respect to the wellbore 101. The remediation operation can involve repairing the casing 102 or cementing behind the casing 102 of the wellbore 101. In an example, the remediation operation can involve using the set of clusters or the determined annular conditions to determine a portion of the casing 102 or the cementing behind the casing 102 to repair or to otherwise perform the remediation operation.

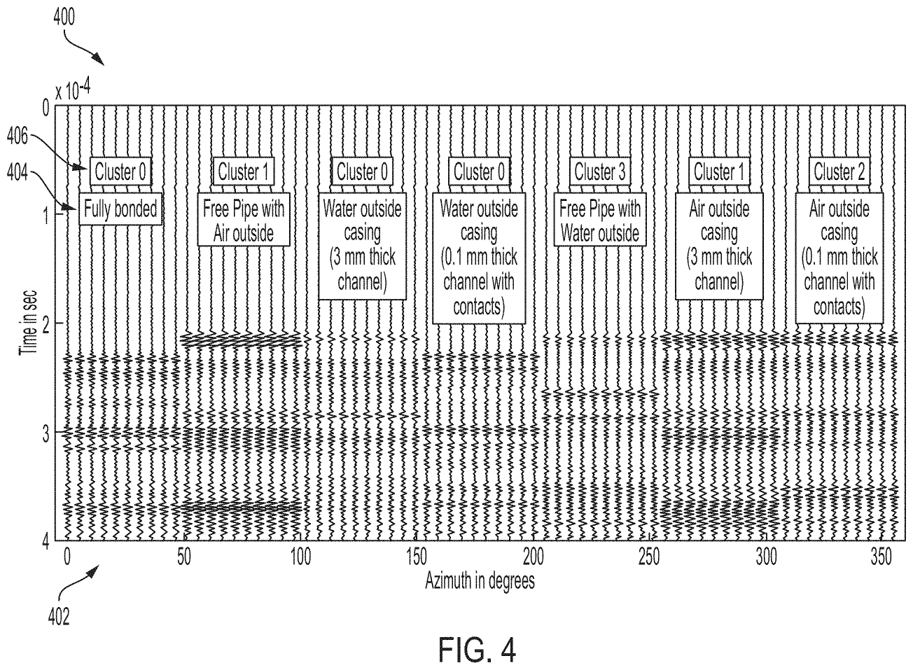

FIG. 4 is an example of synthetic waveforms representing various annular conditions of a wellbore according to one example of the present disclosure. In some examples, the synthetic waveforms can be depicted as an azimuthal scan 400 created with synthetic or other suitable data. In some examples, a significant random noise can be added to an ultrasonic waveform 402 for better understanding or interpreting performance of the clustering algorithm and improving clustering algorithm robustness in the presence of noise. The ultrasonic waveform 402 can represent a corresponding annular condition of identified gaps in the wellbore 101. Each ultrasonic waveform can be labeled as a corresponding annular condition 404 manually or automatically by examining through suitable numerical criteria. Labels for each ultrasonic waveform can be used for measuring the performance of the clustering algorithm by comparing annular conditions within a similar cluster.

In some examples, after the computing devices 140 clusters the ultrasonic waveforms from the azimuths, the clustering algorithm can determine that there are four (or other suitable amounts of) clusters, which represent four primary annular conditions outside the casing. Additionally, each ultrasonic waveform can be classified into a corresponding cluster 406 (e.g. Cluster 0, Cluster 1, Cluster 2, and Cluster 4), which may group similar ultrasonic waveforms with respect to annular conditions. In some examples, each cluster can be represented one of the various annular conditions in the wellbore 101 such as cement (e.g., Cluster 0), free pipe in the air (e.g., Cluster 1), dry microannulus with partial touching (e.g., Cluster 2), free pipe in the water (e.g., Cluster 3) or other suitable labels or annular conditions. By clustering each ultrasonic waveform, each annular condition can be generally classified into an appropriate cluster, which represents one of the possible annular conditions. For example, the water-filled or liquid-filled free pipe or radially deep channel can be separated from the water-filled or liquid-filled radially thin microannulus, which is labeled as Cluster 0 and can be similar to fully bonded.

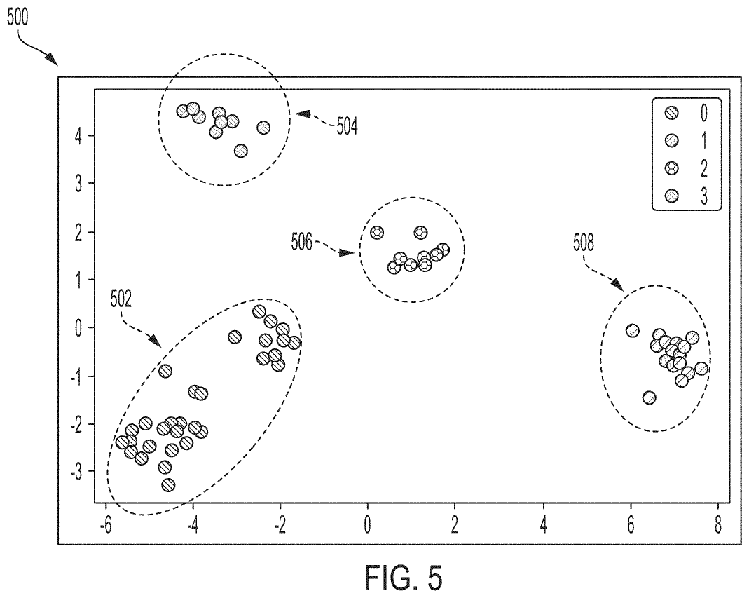

FIG. 5 is an example of clusters output from an unsupervised machine-learning model and associated with ultrasonic waveform data about a wellbore according to one example of the present disclosure. In some examples, the computing device 140 can use one or more optimization methods, for example, the Elbow Method, to determine a suitable amount of clusters for clustering each ultrasonic waveform. For example, an amount of clusters can be determined by the computing device 140 through the optimization method and can obtain four (or other suitable amounts of) clusters as the optimized amount for a set of clusters. Accordingly, a first cluster 502, a second cluster 504, a third cluster 506, and a fourth cluster 508 are illustrated in a two-dimensional plot 500 and may represent four annular conditions, respectively. In some examples, clustering each ultrasonic waveform (e.g., each dot in the diagram) into a respective cluster can allow analysis based on a sum of squared errors (e.g., illustrated in x and y-axis) with respect to attributes or selected attributes associated with a corresponding ultrasonic waveform against a number of clusters to find an optimal amount of clusters. For example, based on the optimized amount of clusters, each ultrasonic waveform (e.g., each dot in the plot 500) can be classified into one of four (or other suitable amounts of) clusters according to an analysis of the sum of squared errors by comparing each attribute to other attributes among the ultrasonic waveforms.

As used below, any reference to a series of examples is to be understood as a reference to each of those examples disjunctively (e.g., “Examples 1-4” is to be understood as “Examples 1, 2, 3, or 4”).

Example 1 is a system comprising: a processor; and a non-transitory computer-readable medium comprising instructions that are executable by the processor for causing the processor to perform operations comprising: receiving ultrasonic waveform data about a wellbore using an arrangement of transducers positionable in the wellbore, the ultrasonic waveform data including a plurality of ultrasonic waveforms; generating a set of attributes of each ultrasonic waveform of the plurality of ultrasonic waveforms; applying an unsupervised machine-learning model to the plurality of ultrasonic waveforms for clustering the set of attributes of each ultrasonic waveform into a set of clusters; and outputting the set of clusters for categorizing the ultrasonic waveform data for determining channels in the wellbore.

Example 2 is the system of example 1, wherein the arrangement of transducers include a pitch-catch arrangement transducers that includes at least one source transducer and at least one receiver transducer, and wherein the ultrasonic waveform data further includes pulse-echo arrangement data for use in the clustering.

Example 3 is the system of example 1, wherein the operation of applying the unsupervised machine-learning model includes selecting at least one attribute from the set of attributes of each ultrasonic waveform for use in clustering the ultrasonic waveform data into the set of clusters.

Example 4 is the system of example 1, wherein the operation of applying the unsupervised machine-learning model includes determining an amount of clusters to use for the clustering using an optimization method, and wherein the optimization method includes Silhouette analysis, the Elbow Method, or the Davies-Bouldin index.

Example 5 is the system of any of examples 1 and 4, wherein the operation of determining the amount of clusters includes determining a reduction of sum of square among the set of attributes.

Example 6 is the system of example 1, wherein the operation of applying the unsupervised machine-learning model includes applying a clustering algorithm that includes K-means clustering, mean-shift clustering, agglomerative hierarchical Clustering, or fuzzy clustering.

Example 7 is the system of example 1, wherein the unsupervised machine-learning model is a first machine-learning model, and wherein the operations further comprise training a second machine-learning model by using the set of clusters as labeled training data.

Example 8 is a method comprising: receiving ultrasonic waveform data about a wellbore using an arrangement of transducers positionable in the wellbore, the ultrasonic waveform data including a plurality of ultrasonic waveforms; generating a set of attributes of each ultrasonic waveform of the plurality of ultrasonic waveforms; applying an unsupervised machine-learning model to the plurality of ultrasonic waveforms for clustering the set of attributes of each ultrasonic waveform into a set of clusters; and outputting the set of clusters for categorizing the ultrasonic waveform data for determining channels in the wellbore.

Example 9 is the method of example 8, wherein the arrangement of transducers include a pitch-catch arrangement transducers that includes at least one source transducer and at least one receiver transducer, and wherein the ultrasonic waveform data further includes pulse-echo arrangement data for use in the clustering.

Example 10 is the method of example 8, wherein applying the unsupervised machine-learning model includes selecting at least one attribute from the set of attributes of each ultrasonic waveform for use in clustering the ultrasonic waveform data into the set of clusters.

Example 11 is the method of example 8, wherein applying the unsupervised machine-learning model includes determining an amount of clusters to use for the clustering using an optimization method, and wherein the optimization method includes Silhouette analysis, the Elbow Method, or the Davies-Bouldin index.

Example 12 is the method of any of examples 8 and 11, wherein determining the amount of clusters includes determining a reduction of sum of square among the set of attributes.

Example 13 is the method of example 8, wherein applying the unsupervised machine-learning model includes applying a clustering algorithm that includes K-means clustering, mean-shift clustering, agglomerative hierarchical Clustering, or fuzzy clustering.

Example 14 is the method of example 8, wherein the unsupervised machine-learning model is a first machine-learning model, further comprising training a second machine-learning model by using the set of clusters as labeled training data.

Example 15 is a non-transitory computer-readable medium comprising instructions that are executable by a processing device for causing the processing device to perform operations comprising: receiving ultrasonic waveform data about a wellbore using an arrangement of transducers positionable in the wellbore, the ultrasonic waveform data including a plurality of ultrasonic waveforms; generating a set of attributes of each ultrasonic waveform of the plurality of ultrasonic waveforms; applying an unsupervised machine-learning model to the plurality of ultrasonic waveforms for clustering the set of attributes of each ultrasonic waveform into a set of clusters; and outputting the set of clusters for categorizing the ultrasonic waveform data for determining channels in the wellbore.

Example 16 is the non-transitory computer-readable medium of example 15, wherein the arrangement of transducers include a pitch-catch arrangement transducers that includes at least one source transducer and at least one receiver transducer, and wherein the ultrasonic waveform data further includes pulse-echo arrangement data for use in the clustering.

Example 17 is the non-transitory computer-readable medium of example 15, wherein the operation of applying the unsupervised machine-learning model includes selecting at least one attribute from the set of attributes of each ultrasonic waveform for use in clustering the ultrasonic waveform data into the set of clusters.

Example 18 is the non-transitory computer-readable medium of example 15, wherein the operation of applying the unsupervised machine-learning model includes determining an amount of clusters to use for the clustering using an optimization method, wherein the optimization method includes Silhouette analysis, the Elbow Method, or the Davies-Bouldin index, and wherein the operation of determining the amount of clusters includes determining a reduction of sum of square among the set of attributes.

Example 19 is the non-transitory computer-readable medium of example 15, wherein the operation of applying the unsupervised machine-learning model includes applying a clustering algorithm that includes K-means clustering, mean-shift clustering, agglomerative hierarchical Clustering, or fuzzy clustering.

Example 20 is the non-transitory computer-readable medium of example 15, wherein the unsupervised machine-learning model is a first machine-learning model, and wherein the operations further comprise training a second machine-learning model by using the set of clusters as labeled training data.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a non-transitory computer-readable medium comprising instructions that are executable by the processor for causing the processor to perform operations comprising:
receiving ultrasonic waveform data about a wellbore using an arrangement of transducers positionable in the wellbore, the ultrasonic waveform data including a plurality of ultrasonic waveforms;
generating a set of attributes of each ultrasonic waveform of the plurality of ultrasonic waveforms;
applying an unsupervised machine-learning model to the plurality of ultrasonic waveforms for clustering the set of attributes of each ultrasonic waveform into a set of clusters; and
outputting the set of clusters for categorizing the ultrasonic waveform data for determining channels in the wellbore.

2. The system of claim 1, wherein the arrangement of transducers include a pitch-catch arrangement transducers that includes at least one source transducer and at least one receiver transducer, and wherein the ultrasonic waveform data further includes pulse-echo arrangement data for use in the clustering.

3. The system of claim 1, wherein the operation of applying the unsupervised machine-learning model includes selecting at least one attribute from the set of attributes of each ultrasonic waveform for use in clustering the ultrasonic waveform data into the set of clusters.

4. The system of claim 1, wherein the operation of applying the unsupervised machine-learning model includes determining an amount of clusters to use for the clustering using an optimization method, and wherein the optimization method includes Silhouette analysis, the Elbow Method, or the Davies-Bouldin index.

5. The system of claim 4, wherein the operation of determining the amount of clusters includes determining a reduction of sum of square among the set of attributes.

6. The system of claim 1, wherein the operation of applying the unsupervised machine-learning model includes applying a clustering algorithm that includes K-means clustering, mean-shift clustering, agglomerative hierarchical Clustering, or fuzzy clustering.

7. The system of claim 1, wherein the unsupervised machine-learning model is a first machine-learning model, and wherein the operations further comprise training a second machine-learning model by using the set of clusters as labeled training data.

8. A method comprising:
receiving ultrasonic waveform data about a wellbore using an arrangement of transducers positionable in the wellbore, the ultrasonic waveform data including a plurality of ultrasonic waveforms;
generating a set of attributes of each ultrasonic waveform of the plurality of ultrasonic waveforms;
applying an unsupervised machine-learning model to the plurality of ultrasonic waveforms for clustering the set of attributes of each ultrasonic waveform into a set of clusters; and
outputting the set of clusters for categorizing the ultrasonic waveform data for determining channels in the wellbore.

9. The method of claim 8, wherein the arrangement of transducers include a pitch-catch arrangement transducers that includes at least one source transducer and at least one receiver transducer, and wherein the ultrasonic waveform data further includes pulse-echo arrangement data for use in the clustering.

10. The method of claim 8, wherein applying the unsupervised machine-learning model includes selecting at least one attribute from the set of attributes of each ultrasonic waveform for use in clustering the ultrasonic waveform data into the set of clusters.

11. The method of claim 8, wherein applying the unsupervised machine-learning model includes determining an amount of clusters to use for the clustering using an optimization method, and wherein the optimization method includes Silhouette analysis, the Elbow Method, or the Davies-Bouldin index.

12. The method of claim 11, wherein determining the amount of clusters includes determining a reduction of sum of square among the set of attributes.

13. The method of claim 8, wherein applying the unsupervised machine-learning model includes applying a clustering algorithm that includes K-means clustering, mean-shift clustering, agglomerative hierarchical Clustering, or fuzzy clustering.

14. The method of claim 8, wherein the unsupervised machine-learning model is a first machine-learning model, further comprising training a second machine-learning model by using the set of clusters as labeled training data.

15. A non-transitory computer-readable medium comprising instructions that are executable by a processing device for causing the processing device to perform operations comprising:
receiving ultrasonic waveform data about a wellbore using an arrangement of transducers positionable in the wellbore, the ultrasonic waveform data including a plurality of ultrasonic waveforms;
generating a set of attributes of each ultrasonic waveform of the plurality of ultrasonic waveforms;
applying an unsupervised machine-learning model to the plurality of ultrasonic waveforms for clustering the set of attributes of each ultrasonic waveform into a set of clusters; and
outputting the set of clusters for categorizing the ultrasonic waveform data for determining channels in the wellbore.

16. The non-transitory computer-readable medium of claim 15, wherein the arrangement of transducers include a pitch-catch arrangement transducers that includes at least one source transducer and at least one receiver transducer, and wherein the ultrasonic waveform data further includes pulse-echo arrangement data for use in the clustering.

17. The non-transitory computer-readable medium of claim 15, wherein the operation of applying the unsupervised machine-learning model includes selecting at least one attribute from the set of attributes of each ultrasonic waveform for use in clustering the ultrasonic waveform data into the set of clusters.

18. The non-transitory computer-readable medium of claim 15, wherein the operation of applying the unsupervised machine-learning model includes determining an amount of clusters to use for the clustering using an optimization method, wherein the optimization method includes Silhouette analysis, the Elbow Method, or the Davies-Bouldin index, and wherein the operation of determining the amount of clusters includes determining a reduction of sum of square among the set of attributes.

19. The non-transitory computer-readable medium of claim 15, wherein the operation of applying the unsupervised machine-learning model includes applying a clustering algorithm that includes K-means clustering, mean-shift clustering, agglomerative hierarchical Clustering, or fuzzy clustering.

20. The non-transitory computer-readable medium of claim 15, wherein the unsupervised machine-learning model is a first machine-learning model, and wherein the operations further comprise training a second machine-learning model by using the set of clusters as labeled training data.
